(19) United States
(12) Patent Application Publication
(10) Pub. No.: US 2026/0001398 A1
(43) Pub. Date: Jan. 1, 2026

(54) SYSTEMS AND METHODS FOR INCREASING VOICE RECOGNITION RATE

(71) Applicants: Hyundai Motor Company, Seoul (KR); Kia Corporation, Seoul (KR)

(72) Inventor: Ashwin Kulkarni, Superior Township, MI (US)

(21) Appl. No.: 18/756,110

(22) Filed: Jun. 27, 2024

(51) Int. Cl. B60K 35/10; G10L 15/22

(52) U.S. Cl. CPC B60K 35/10; G10L 15/22; B60K 2360/148; B60K 2360/782

(57) ABSTRACT

Voice recognition (VR) systems and methods for performing VR are provided. The VR system may comprise one or more microphones, one or more speakers, and a computing device, comprising a processor, a memory, and a plurality of buttons. Each button may be associated with a VR functionality, of a plurality of VR functionalities. Each VR functionality may have one or more grammar domains associated with it. The memory may be configured to store instructions that, when executed by the processor, are configured to cause the processor to receive an input from one of the plurality of buttons, specifying a VR functionality, disable one or more grammar domains not associated with the specified VR functionality, receive an audio input, via the one or more microphones, and analyze the audio input absent the disabled one or more grammar domains to determine one or more VR commands from the audio input.

### BACKGROUND

### Technical Field

Embodiments of the present disclosure relate to systems and methods for increasing a voice recognition (VR) rate by disabling grammar.

### Background

Many vehicles have integrated voice recognition (V R) into their functionality. The success of a VR session in a vehicle is usually affected by many factors such as, e.g., road noise, user accent, the timing of giving a voice command, etc. VR in vehicles is often used in conjunction with a voice user interface (VUI).

VR in vehicles often incorporates one or more voice commands, whereby the vehicle is configured to perform a function when a voice command is spoken. However, present VUI design is based on a user knowing the commands before using VR, The user is expected to know exact command wordings, otherwise the system will not recognize the command.

Typically, a user will be able to learn about supported commands only after any of following: (1) a user voice command training (e.g., by the vehicle dealer, by a call center, etc.); (2) a user's own method of trial and error; and/or (3) a user learning voice commands by exploring help literature (e.g., the car manual, help screens displayed inside infotainment, etc.).

### SUMMARY

According to an object of the present disclosure, a voice recognition (VR) system is provided. The VR system may comprise one or more microphones, one or more speakers, and a computing device, comprising a processor, a memory, and a plurality of buttons. Each button, of the plurality of buttons, may be associated with a VR functionality, of a plurality of VR functionalities, Each VP functionality, of the plurality of VR functionalities, may have one or more grammar domains associated with it. The memory may be configured to store instructions that, when executed by the processor, are configured to cause the processor to receive an input from one of the plurality of buttons, specifying a VR functionality, disable one or more grammar domains not associated with the specified VR functionality, receive an audio input from a user, via the one or more microphones, and analyze the audio input absent the disabled one or more grammar domains to determine one or more VR commands from the audio input.

According to an exemplary embodiment, the VR system may further comprise a vehicle. The computing device may be coupled to the vehicle.

According to an exemplary embodiment, the vehicle may comprise a steering wheel. The plurality of buttons may be positioned on the steering wheel.

According to an exemplary embodiment, the plurality of VR functionalities may comprise at least one of the following: a phone control VR functionality; a radio/media control VR functionality; and a navigation control VR functionality.

According to an exemplary embodiment, the instructions, when executed by the processor, may be further configured to cause the processor to disable one or more additional grammar domains based on the audio input.

According to an exemplary embodiment, the instructions, when executed by the processor, may be further configured to cause the processor to request audio input from the user, using the one or more speakers.

According to an exemplary embodiment, the instructions, when executed by the processor, may be further configured to cause the processor to implement the one or more VR commands.

According to an exemplary embodiment, the implementing the one or more VR commands may comprise performing one or more of the following: dialing a phone number; tuning to a radio station; playing a media source type, using the one or more speakers; and generating directions to an address.

According to an object of the present disclosure, a method for performing VR is provided. The method may comprise receiving an input from a button, of a plurality of buttons of a computing device. Each button, of the plurality of buttons, may be associated with a VR functionality, of a plurality of VR functionalities. The input from the button may specify a VR functionality. Each VR functionality, of the plurality of VR functionalities, may have one or more grammar domains associated with it. The computing device may comprise a processor, a memory, and the plurality of buttons. The method may comprise disabling, using the computing device, one or more grammar domains not associated with the specified VR functionality, receiving, using one or more microphones, an audio input from a user, and analyzing, using the computing device, the audio input absent the disabled one or more grammar domains to determine one or more VR commands from the audio input.

According to an exemplary embodiment, the computing device may be coupled to a vehicle.

According to an exemplary embodiment, the vehicle may comprise a steering wheel, and the plurality of buttons may be positioned on the steering wheel.

According to an exemplary embodiment, the plurality of VR functionalities may comprise at least one of the following: a phone control VR functionality; a radio/media control VR functionality; and a navigation control VR functionality.

According to an exemplary embodiment, the method may further comprise disabling, using the computing device, one or more additional grammar domains based on the audio input.

According to an exemplary embodiment, the method may further comprise, using the computing device, requesting audio input from the user.

According to an exemplary embodiment, the requesting may be performed using one or more speakers.

According to an exemplary embodiment, the method may further comprise implementing the one or more VR commands.

According to an exemplary embodiment, the implementing the one or more VR commands may comprise performing one or more of the following: dialing a phone number; tuning to a radio station; playing a media source type, using the one or more speakers; and generating directions to an address.

### BRIEF DESCRIPTION OF THE DRAWINGS

The accompanying drawings, which are incorporated in and form a part of the Detailed Description, illustrate various non-limiting and non-exhaustive embodiments of the subject matter and, together with the Detailed Description, serve to explain principles of the subject matter discussed below. Unless specifically noted, the drawings referred to in this Brief Description of Drawings should be understood as not being drawn to scale and like reference numerals refer to like parts throughout the various figures unless otherwise specified.

FIG. 1 illustrates a vehicle configured to receive and implement one or more voice recognition (VR) commands, according to an exemplary embodiment of the present disclosure.

FIG. 2 illustrates a steering wheel with buttons dedicated to different VR functionalities, according to an exemplary embodiment of the present disclosure.

FIG. 3 illustrates a flowchart of a method for performing VR phone control operation, according to an exemplary embodiment of the present disclosure.

FIG. 4 illustrates a flowchart of a method for performing V R radio/media control operation, according to an exemplary embodiment of the present disclosure.

FIG. 5 illustrates a flowchart of a method for performing V R navigation control operation, according to an exemplary embodiment of the present disclosure.

FIG. 6 illustrates an example architecture of a vehicle, according to an exemplary embodiment of the present disclosure.

FIG. 7 illustrates example elements of a computing device, according to an exemplary embodiment of the present disclosure.

### DETAILED DESCRIPTION

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In aspects, a vehicle may comprise an internal combustion engine system as disclosed herein.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%. 2%, 1%, 0.5%, 0.1%. 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

According to exemplary embodiments, systems and methods for increasing a voice recognition (VR) rate by disabling grammar are provided.

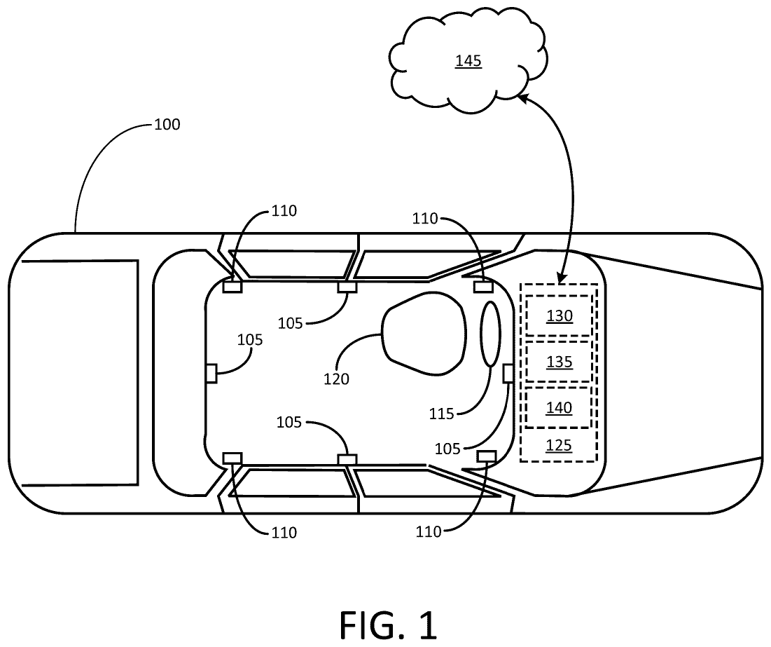

Referring now to FIG. 1, a vehicle 100 configured to receive and implement one or more VR commands is illustratively depicted, in accordance with an exemplary embodiment of the present disclosure. According to an exemplary embodiment, the vehicle 100 may comprise an electric vehicle and/or other suitable vehicle.

According to an exemplary embodiment, the vehicle 100 may comprise one or more sensors such as, for example, one or more microphones 105 configured to detect and/or record sounds (e.g., user voice sounds). According to an exemplary embodiment, the vehicle 100 may comprise one or more speakers 110 configured to play one or more sounds.

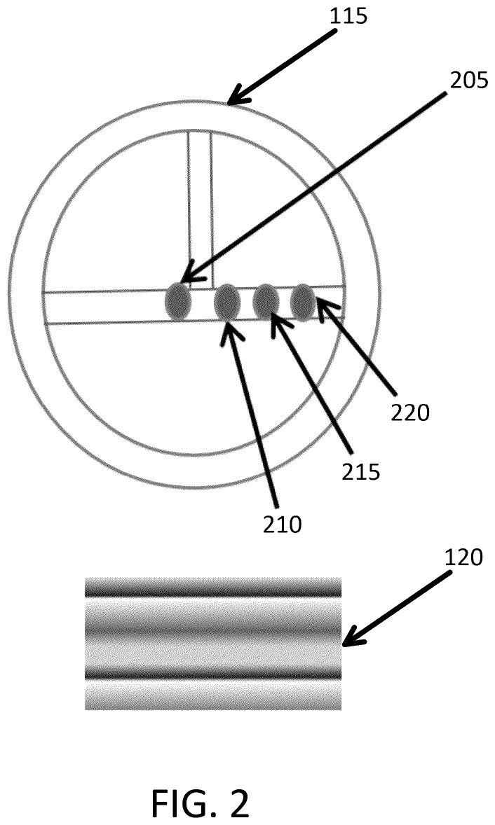

According to an exemplary embodiment, the vehicle 100 may comprise a steering wheel 115 comprising one or more buttons (e.g., buttons 205, 210, 215, 220 as shown, e.g., in FIG. 2) dedicated to different VR functionalities. Each VR functionality may have one or more grammar domains associated with it.

The steering wheel 115 may be positioned in front of the driver seat 120 of the vehicle 100. It is noted, however, that the buttons may be positioned on one or more other locations within the vehicle 100 while maintaining the spirit and functionality of the present disclosure.

According to an exemplary embodiment, the vehicle 100 may comprise a computing device 125. The computing device 125 may comprise a processor 130, a memory 135, and/or a user interface 140 (e.g., a graphical user interface). The computing device 125 may be configured to send and/or receive commands/data/input/etc. via one or more external systems via wired and/or wireless connection (e.g., via the cloud 145).

According to an exemplary embodiment, the one or more microphones 105 and/or the one or more speakers 110 may be in electronic communication with the one or more computing devices 125. The one or more computing devices 125 may be separate from the one or more microphones 105 and/or the one or more speakers 110 and/or may be incorporated into the one or more microphones 105 and/or the one or more speakers 110.

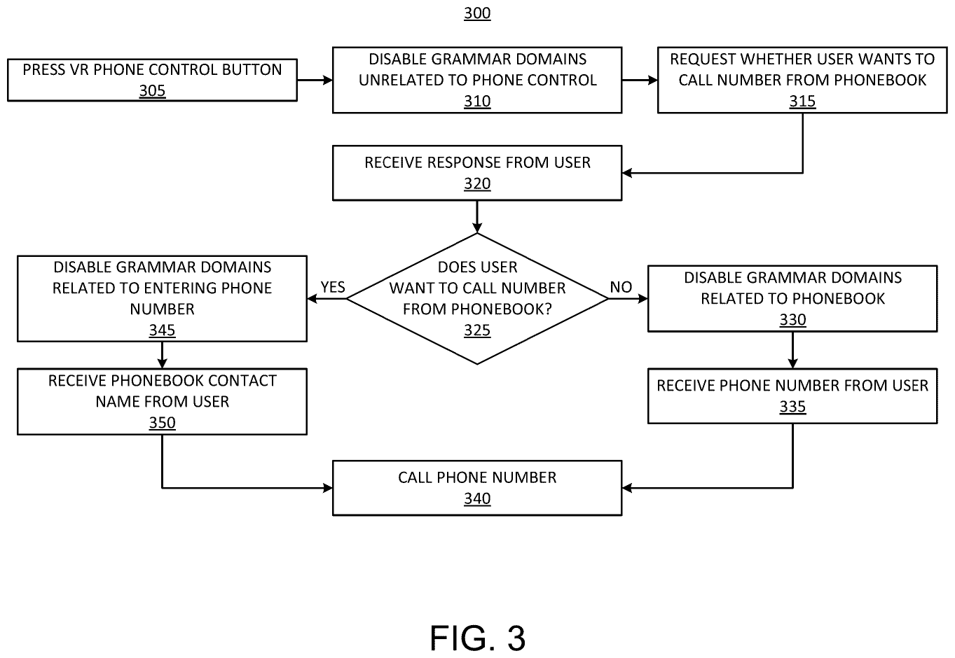

The memory 135 may be configured to store programming instructions that, when executed by the processor 130, may be configured to cause the processor 130 to perform one or more tasks such as, e.g., receiving one or more inputs from one or more microphones 110 and/or buttons 205, 210, 215, 220, recognizing one or more VR commands, analyzing audio input absent any disabled grammar domains to determine one or more VR commands from the audio input (as shown, e.g., in FIGS. 3-5), implementing one or more VR commands, and/or performing other suitable tasks.

Referring now to FIG. 2, a steering wheel 115 with buttons 205, 210, 215, 220 dedicated to different VR functionalities is illustratively depicted, in accordance with an exemplary embodiment of the present disclosure.

According to an exemplary embodiment, the steering wheel 115 may comprise multiple different buttons (e.g., buttons 205, 210, 215, 220). As shown in FIG. 2, there are four separate buttons (buttons 205, 210, 215, 220). It is noted, however, that the vehicle 100 and/or steering wheel 115 may comprise fewer or more buttons, as needed, incorporating more or fewer VR functionalities while maintaining the spirit and functionality of the present disclosure. According to an exemplary embodiment, each button may be configured to start a VR session, Each button may be dedicated to a single functionality which can be controlled using VR.

According to an exemplary embodiment, one button 205 may be dedicated for normal VR operation, one button 210 may be dedicated for phone control operation, one button 215 may be dedicated for radio/media control operation, and/or one button 220 may be dedicated for navigation control operation. It is noted, however, that the functionalities of buttons 205, 210, 215, and 220 are shown by way of example, that the vehicle 100 may comprise greater or fewer buttons, and that one or more other VR functionalities may be controlled by one or more buttons in addition to, or instead of, the functionalities described for buttons 205, 210, 215, and 220. According to an exemplary embodiment, the vehicle 100 may be configured to add one or more new buttons for one or more additional functionalities and/or update a functionality of one or more existing buttons.

According to an exemplary embodiment, a user may be expected to press the button based on the functionality which the user intends to use. For example, if the user intends to dial a number to make a phone call, the user may press the button 210 dedicated for phone control operation to start a VR session dedicated for phone operation, and likewise press the appropriate button for starting other suitable VR sessions.

According to an exemplary embodiment, the computing device 125 may be configured to tune grammar specifically for commands related to the features of a particular VR session, increasing VR performance. According to an exemplary embodiment, when the button 205 dedicated for normal VR operation is pressed, the vehicle 100 receives an input from button 205 and all grammar domains (e.g., phone grammar domains, radio grammar domains, media grammar domains, navigation grammar domains, and/or other suitable grammar domains) to be enabled.

According to an exemplary embodiment, with the press of a specific button, the computing device 125 may be configured to switch on a question and answer mode to try to determine which operation the user wants performed and, based on each selection, may disable selective grammar to improve recognition results (as shown, e.g., in methods 300, 400, and 500). Based on the choice of mode of operation and/or what the user wants the computing device 125 to do, other grammar domains may be disabled, progressively, increasing VR accuracy and recognition rates.

Referring now to FIG. 3, a flowchart of a method 300 for performing VR phone control operation is illustratively depicted, in accordance with an exemplary embodiment of the present disclosure.

At 305, a user may press the button associated with VR phone control operation. Upon pressing the button associated with VR phone control operation, the vehicle, at 310, enters the VR phone control functionality and disables grammar domains unrelated to phone control (e.g., radio grammar domains, media grammar domains, navigation grammar domains, and/or other suitable grammar domains).

At 315, the vehicle, using a voice user interface (VUI), requests that the user indicate whether the user wants to call a phone number from the user's phonebook. According to an exemplary embodiment, the VUI may comprise one or more speakers and/or one or more microphones coupled to the vehicle. At 320, the vehicle receives the response from the user (via, e.g., audio input), using one or more microphones, and, at 325, analyzes the response to determine whether the user wants to call a phone number from the user's phonebook.

At 330, when the user does not want to call a phone number from the user's phonebook, the vehicle disables grammar domains associated with the user's phonebook and, at 335, receives a phone number from the user (via, e.g., audio input), using the one or more microphones. At 340, the vehicle calls the phone number.

At 345, when the user does want to call a phone number from the user's phonebook, the vehicle disables grammar domains unrelated to entering a phone number not associated with a contact within the user's phonebook. At 350, the vehicle receives a phonebook contact name from the user (via, e.g., audio input), using the one or more microphones, and, at 340, calls the phone number associated with that contact name.

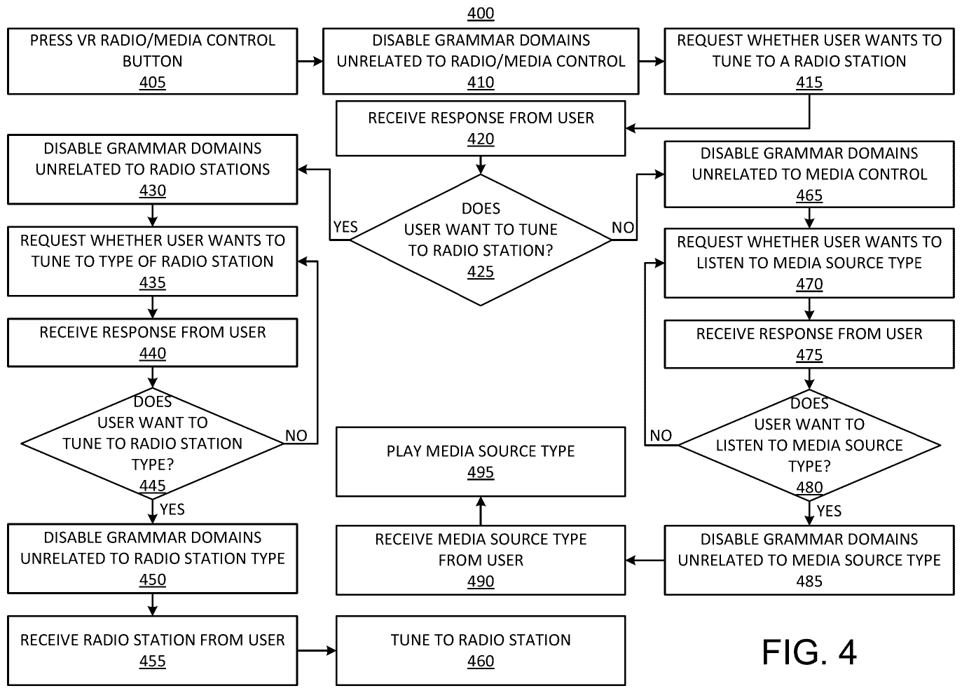

Referring now to FIG. 4, a flowchart of a method 400 for performing VR radio/media control operation is illustratively depicted, in accordance with an exemplary embodiment of the present disclosure.

At 405, a user may press the button associated with VR radio/media control operation, causing the vehicle to receive an input from the button associated with VR radio/media control operation. Upon pressing the button associated with VR radio/media control operation, the vehicle, at 410, enters the VR radio/media control functionality and disables grammar domains unrelated to radio/media control (e.g., phone grammar domains, navigation grammar domains, and/or other suitable grammar domains).

At 415, the vehicle, using the VUI, requests that the user indicate whether the user wants to tune to a radio station. According to an exemplary embodiment, the VUI may comprise one or more speakers coupled to the vehicle. At 420, the vehicle receives the response from the user (via, e.g., audio input), using one or more microphones, and, at 425, analyzes the response to determine whether the user wants to tune to a radio station.

At 430, when the user does want to tune to a radio station, the vehicle disables grammar domains unrelated to entering radio stations. At 435, the vehicle, using the VUI, requests that the user indicate whether the user wants to tune to a type of radio station (e.g., an AM radio station, an FM, radio station, an Internet radio station, a satellite radio station, and/or other suitable type of radio station) and, at 440, receives a response from the user (via, e.g., audio input). At 445, the vehicle analyzes the response to determine whether the user wants to tune to a specific type of radio station. According to an exemplary embodiment, when the user does not want to tune to a specific type of radio station, then, at 435, the vehicle, using the VUI, may again request that the user indicate whether the user wants to tune to a type of radio station. When the user does want to tune to a specific type of radio station, then, at 450, the vehicle may disable grammar domains unrelated to the specific type of radio station.

At 455, the vehicle receives a specified radio station from the user pertaining to the specific radio station type (via, e.g., audio input) and, at 460, tunes to the specified radio station.

At 465, when the user does not want to tune to a radio station, the vehicle disables grammar domains unrelated to media control. At 470, the vehicle, using the VUI, requests that the user indicate whether the user wants to listen to a type of media source (e.g., a universal serial bus (USB), an auxiliary port, a wired and/or wireless connection to a data source, and/or other suitable type of media source) and, at 475, receives a response from the user (via, e.g., audio input). At 480, the vehicle analyzes the response to determine whether the user wants to listen to a specific type of media source. According to an exemplary embodiment, when the user does not want to listen to a specific type of media source, then, at 470, the vehicle, using the VUI, may again request that the user indicate whether the user wants to listen to a type of media source. When the user does want to listen to a specific type of media source, then, at 485, the vehicle may disable grammar domains unrelated to the specific type of media source.

At 490, the vehicle receives a specified media source from the user (via, e.g., audio input) and, at 495, plays the specific media source.

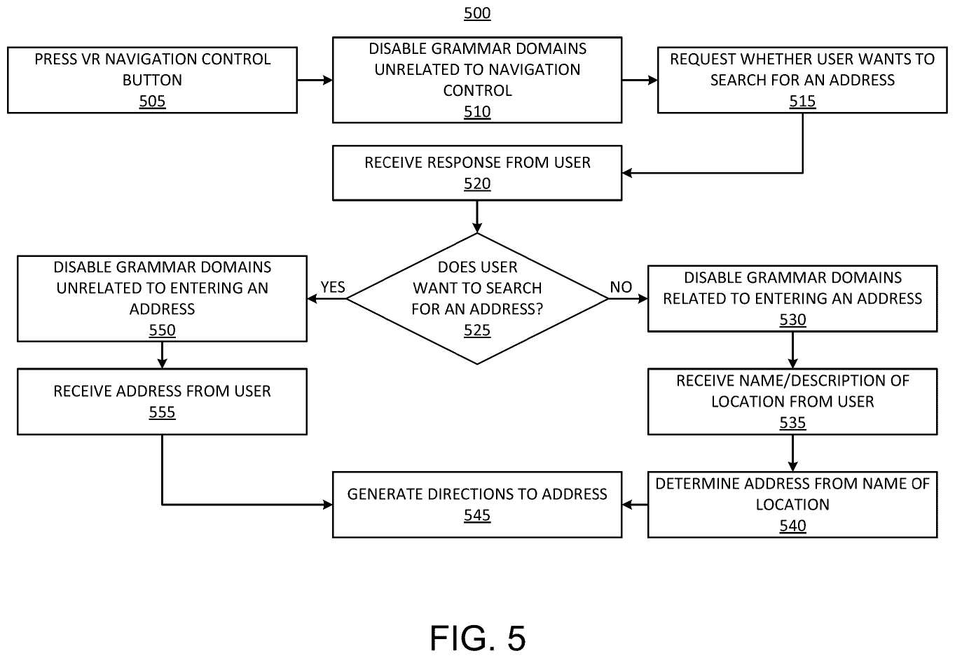

Referring now to FIG. 5, a flowchart of a method 500 for performing VR navigation control operation is illustratively depicted, in accordance with an exemplary embodiment of the present disclosure.

At 505, a user may press the button associated with VR navigation control operation, Upon pressing the button associated with VR navigation control operation, the vehicle, at 510, enters the VR navigation control functionality and disables grammar domains unrelated to navigation control (e.g., phone grammar domains, radio grammar domains, media grammar domains, and/or other suitable grammar domains).

At 515, the vehicle, using the VUI, requests that the user indicate whether the user wants to search for an address. According to an exemplary embodiment, the VUI may comprise one or more speakers coupled to the vehicle. At 520, the vehicle receives the response from the user (via, e.g., audio input), using one or more microphones, and, at 525, analyzes the response to determine whether the user wants to search for an address.

At 530, when the user does not want to search for an address, the vehicle disables grammar domains associated with entering an address and, at 535, receives a name and/or description of a location from the user (via, e.g., audio input), using the one or more microphones. At 540, the vehicle may determine an address of the location based on the name and/or description of the location received by the user. At 545, the vehicle generates directions to the address. According to an exemplary embodiment, generating directions may comprise displaying a route, using a display of a graphical user interface, for the vehicle to follow to reach the address.

At 550, when the user does want to search for an address, the vehicle disables grammar domains unrelated to entering an address. At 555, the vehicle receives an address from the user (via, e.g., audio input), using the one or more microphones. At 545, the vehicle generates directions to the address. According to an exemplary embodiment, generating directions may comprise displaying a route, using a display of a graphical user interface, for the vehicle to follow to reach the address.

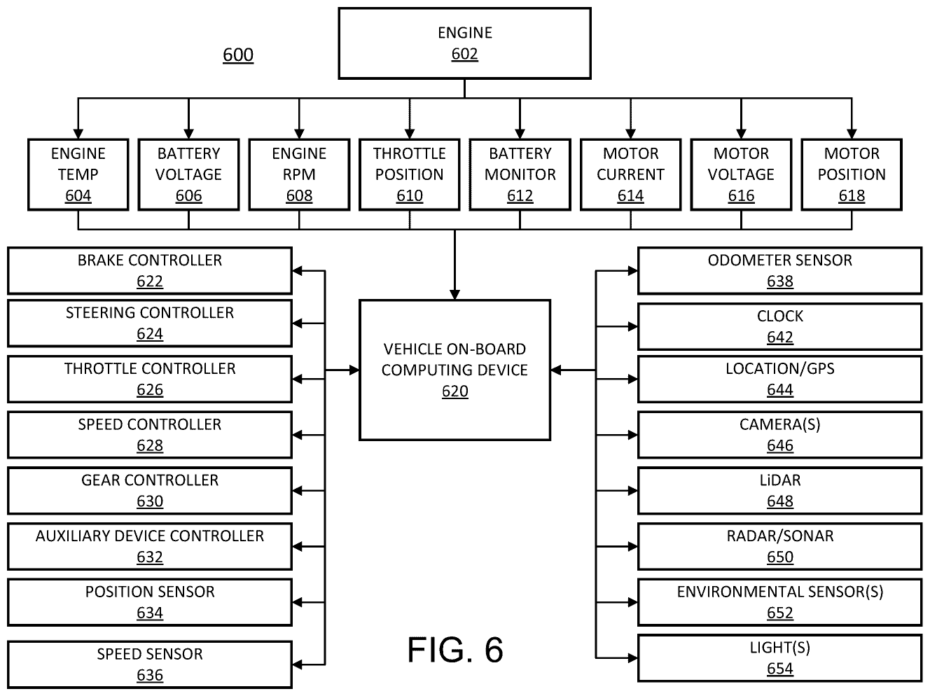

Referring now to FIG. 6, an example vehicle system architecture 600 for a vehicle is provided, in accordance with an exemplary embodiment of the present disclosure. The following discussion of vehicle system architecture 600 is sufficient for understanding one or more components of vehicle 100.

As shown in FIG. 6, the vehicle system architecture 600 may comprise an engine, motor or propulsive device 602 and various sensors 604-618 for measuring various parameters of the vehicle system architecture 600. In gas-powered or hybrid vehicles having a fuel-powered engine, the sensors 604-618 may comprise, for example, an engine temperature sensor 604, a battery voltage sensor 606, an engine Rotations Per Minute (RPM) sensor 608, and/or a throttle position sensor 610. If the vehicle is an electric or hybrid vehicle, then the vehicle may comprise an electric motor, and accordingly may comprise sensors such as a battery monitoring system 612 (to measure current, voltage and/or temperature of the battery), motor current 614 and voltage 616 sensors, and motor position sensors such as resolvers and encoders 618.

Operational parameter sensors that are common to both types of vehicles may comprise, for example: a position sensor 634 such as an accelerometer, gyroscope and/or inertial measurement unit; a speed sensor 636; and/or an odometer sensor 638. The vehicle system architecture 600 also may comprise a clock 642 that the system uses to determine vehicle time and/or date during operation. The clock 642 may be encoded into the vehicle on-board computing device 620, it may be a separate device, or multiple clocks may be available.

The vehicle system architecture 600 may comprise various sensors that operate to gather information about the environment in which the vehicle is traveling. These sensors may comprise, for example: a location sensor 644 (for example, a Global Positioning System (GPS) device); object detection sensors such as one or more cameras 646; a LiDAR sensor system 648; and/or a radar and/or a sonar system 650. The sensors may comprise environmental sensors 652 such as, e.g., a humidity sensor, a precipitation sensor, a light sensor, and/or ambient temperature sensor. The object detection sensors may be configured to enable the vehicle system architecture 600 to detect objects that are within a given distance range of the vehicle in any direction, while the environmental sensors 652 may be configured to collect data about environmental conditions within the vehicle's area of travel. According to an exemplary embodiment, the vehicle system architecture 600 may comprise one or more lights 654 (e.g., headlights, flood lights, flashlights, etc.).

During operations, information may be communicated from the sensors to an on-board computing device 620 (e.g., computing device 125, computing device 700). The on-board computing device 620 may be configured to analyze the data captured by the sensors and/or data received from data providers and may be configured to optionally control operations of the vehicle system architecture 600 based on results of the analysis. For example, the on-board computing device 620 may be configured to control: braking via a brake controller 622; direction via a steering controller 624; speed and acceleration via a throttle controller 626 (in a gas-powered vehicle) or a motor speed controller 628 (such as a current level controller in an electric vehicle); a differential gear controller 630 (in vehicles with transmissions); and/or other controllers. The brake controller 622 may comprise a pedal effort sensor, pedal effort sensor, and/or simulator temperature sensor, as described herein.

Geographic location information may be communicated from the location sensor 644 to the on-board computing device 620, which may then access a map of the environment that corresponds to the location information to determine known fixed features of the environment such as streets, buildings, stop signs and/or stop/go signals. Captured images from the cameras 646 and/or object detection information captured from sensors such as LiDAR 648 may be communicated from those sensors to the on-board computing device 620. The object detection information and/or captured images may be processed by the on-board computing device 620 to detect objects in proximity to the vehicle. Any known or to be known technique for making an object detection based on sensor data and/or captured images may be used in the embodiments disclosed in this document.

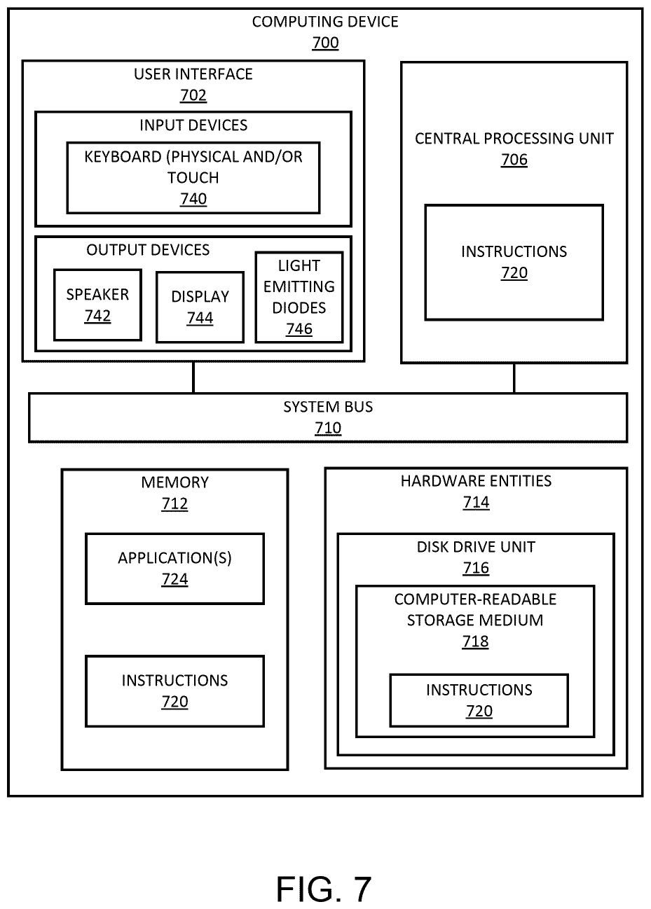

Referring now to FIG. 7, an illustration of an example architecture for a computing device 700 is provided. According to an exemplary embodiment, one or more functions of the present disclosure may be implemented by a computing device such as, e.g., computing device 700 or a computing device similar to computing device 700. Computing device 700 may be a quantum computer, a classical computer, and/or have one or more components configured to perform one or more quantum and/or classical computing functions. Computing device 125 and/or computing device 620 may be an example of computing device 700 and/or may comprise one or more components of computing device 700.

The hardware architecture of FIG. 7 represents one example implementation of a representative computing device configured to implement at least a portion of the systems/devices (e.g., vehicle 100) and method(s)/control logic(s) (e.g., method 300, method 400, and method 500) described herein.

Some or all components of the computing device 700 may be implemented as hardware, software, and/or a combination of hardware and software. The hardware may comprise, but is not limited to, one or more electronic circuits. The electronic circuits may comprise, but are not limited to, passive components (e.g., resistors and capacitors) and/or active components (e.g., amplifiers and/or microprocessors). The passive and/or active components may be adapted to, arranged to, and/or programmed to perform one or more of the methodologies, procedures, or functions described herein.

As shown in FIG. 7, the computing device 700 may comprise a user interface 702 (e.g., a graphical user interface), a Central Processing Unit (“CPU”) 706, a system bus 710, a memory 712 connected to and accessible by other portions of computing device 700 through system bus 710, and hardware entities 714 connected to system bus 710. The user interface may comprise input devices and output devices, which may be configured to facilitate user-software interactions for controlling operations of the computing device 700. The input devices may comprise, but are not limited to, a physical and/or touch keyboard 740. The input devices may be connected to the computing device 700 via a wired or wireless connection (e.g., a Bluetooth® connection). The output devices may comprise, but are not limited to, a speaker 742, a display 744, and/or light emitting diodes 746.

At least some of the hardware entities 714 may be configured to perform actions involving access to and use of memory 712, which may be a Random Access Memory (RAM), a disk driver and/or a Compact Disc Read Only Memory (CD-ROM), among other suitable memory types. Hardware entities 714 may comprise a disk drive unit 716 comprising a computer-readable storage medium 718 on which may be stored one or more sets of instructions 720 (e.g., programming instructions such as, but not limited to, software code) configured to implement one or more of the methodologies, procedures, or functions described herein. The instructions 720 may also reside, completely or at least partially, within the memory 712 and/or within the CPU 706 during execution thereof by the computing device 700.

The memory 712 and the CPU 706 may also constitute machine-readable media. The term “machine-readable media”, as used here, refers to a single medium or multiple media (e.g., a centralized or distributed database, and/or associated caches and servers) that store the one or more sets of instructions 720. The term “machine-readable media”, as used here, also refers to any medium that is capable of storing, encoding, or carrying a set of instructions 720 for execution by the computing device 600 and that cause the computing device 700 to perform any one or more of the methodologies of the present disclosure. According to various embodiments, one or more computer applications 724 may be stored on the memory 712.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed.

What is claimed is:

1. A voice recognition (VR) system, comprising:
one or more microphones;
one or more speakers; and
a computing device, comprising a processor, a memory, and a plurality of buttons,
wherein:
each button, of the plurality of buttons, is associated with a VR functionality, of a plurality of VR functionalities,
each VR functionality, of the plurality of VR functionalities, has one or more grammar domains associated with it, and
the memory is configured to store instructions that, when executed by the processor, are configured to cause the processor to:
receive an input from one of the plurality of buttons, specifying a VR functionality;
disable one or more grammar domains not associated with the specified VR functionality;
receive an audio input from a user, via the one or more microphones; and
analyze the audio input absent the disabled one or more grammar domains to determine one or more VR commands from the audio input.

2. The VR system of claim 1, further comprising a vehicle,
wherein the computing device is coupled to the vehicle.

3. The VR system of claim 2, wherein:
the vehicle comprises a steering wheel, and
the plurality of buttons are positioned on the steering wheel.

4. The VR system of claim 1, wherein the plurality of VR functionalities comprises at least one of the following:
a phone control VR functionality;
a radio/media control VR functionality; and
a navigation control VR functionality.

5. The VR system of claim 1, wherein the instructions, when executed by the processor, are further configured to cause the processor to disable one or more additional grammar domains based on the audio input.

6. The VR system of claim 1, wherein the instructions, when executed by the processor, are further configured to cause the processor to request audio input from the user, using the one or more speakers.

7. The VR system of claim 1, wherein the instructions, when executed by the processor, are further configured to cause the processor to implement the one or more VR commands.

8. The VR system of claim 7, wherein the implementing the one or more VR commands comprises performing one or more of the following:
dialing a phone number;
tuning to a radio station;
playing a media source type, using the one or more speakers; and
generating directions to an address.

9. A method for performing voice recognition (VR), comprising:
receiving an input from a button, of a plurality of buttons of a computing device,
wherein:
each button, of the plurality of buttons, is associated with a VR functionality, of a plurality of VR functionalities,
the input from the button specifies a VR functionality,
each VR functionality, of the plurality of VR functionalities, has one or more grammar domains associated with it, and
the computing device comprises a processor, a memory, and the plurality of buttons;
disabling, using the computing device, one or more grammar domains not associated with the specified VR functionality;
receiving, using one or more microphones, an audio input from a user; and
analyzing, using the computing device, the audio input absent the disabled one or more grammar domains to determine one or more VR commands from the audio input.

10. The method of claim 9, wherein the computing device is coupled to a vehicle.

11. The method of claim 10, wherein:
the vehicle comprises a steering wheel, and
the plurality of buttons are positioned on the steering wheel.

12. The method of claim 9, wherein the plurality of VR functionalities comprises at least one of the following:
a phone control VR functionality;
a radio/media control VR functionality; and
a navigation control VR functionality.

13. The method of claim 9, further comprising disabling, using the computing device, one or more additional grammar domains based on the audio input.

14. The method of claim 9, further comprising, using the computing device, requesting audio input from the user.

15. The method of claim 14, wherein the requesting is performed using one or more speakers.

16. The method of claim 9, further comprising implementing the one or more VR commands.

17. The method of claim 16, wherein the implementing the one or more VR commands comprises performing one or more of the following:
dialing a phone number;
tuning to a radio station;
playing a media source type, using the one or more speakers; and
generating directions to an address.
